(19) United States
(12) Patent Application Publication
(10) Pub. No.: US 2014/0242213 A1
(43) Pub. Date: Aug. 28, 2014

(54) FEEDING SYSTEM FOR INFANTS

(71) Applicants: Read McCarty, Hingham, MA (US); Charles H. Rogers, Halifax, MA (US); Jerome Issa, Norwood, MA (US); Vincent G. D'Agostino, Walpole, MA (US)

(72) Inventors: Read McCarty, Hingham, MA (US); Charles H. Rogers, Halifax, MA (US); Jerome Issa, Norwood, MA (US); Vincent G. D'Agostino, Walpole, MA (US)

(21) Appl. No.: 14/126,538

(22) PCT Filed: Jun. 15, 2012
(86) PCT No.: PCT/US12/42562

§ 371 Date: Apr. 29, 2014

Related U.S. Application Data
(60) Provisional application No. 61/520,883, filed on Jun. 16, 2011.

(51) Int. Cl. A61J 9/00; A23L 1/29

(52) U.S. Cl. CPC A61J 9/00; A23L 1/293
USPC 426/2; 222/490; 222/146.2; 222/372; 222/23

(57) ABSTRACT

A feeding system for a neonate is provided that includes a fluid reservoir adapted to contain fluid to be provided to the neonate, a nipple in fluid communication with the fluid reservoir having at least one fluid outlet adapted to enable the neonate to take the fluid therefrom by mouth and a control system adapted to automatically maintain the pressure in the fluid reservoir substantially neutral relative to the pressure external to the fluid outlet as the fluid is taken by the neonate. The feeding system may also include a heating system adapted to warm the fluid and to automatically maintain the temperature of the fluid in the reservoir at a temperature near the body temperature of the neonate as the fluid is provided to the neonate.

### FIELD OF THE INVENTION

The present invention relates to feeding systems for infants and specifically to feeding systems for premature or low birth weight infants or other medically fragile infants who receive nutritive fluid feed orally or from a feeding tube.

### BACKGROUND OF THE INVENTION

Some premature or low birth weight babies have such immature neurological systems that they have no suckling reflex and must be fed through an oral gastric or nasogastric (NG) tube. As the infants mature, the caregivers introduce them to bottle feeding providing them formula or expressed breast milk in a bottle with a nipple. Oral feeding competency is required for hospital discharge, but many babies have difficulty learning the neuro-behavioral skills needed to drink from a baby bottle. The inventors believe that this important neuro-behavioral development is hampered by the inconsistent environment created by current feeding practices and equipment. The temperature of the feed is not controlled or regulated and differences in feed temperature have been observed ranging from 50° F. to over 100° F. The majority of feeds that are warmed are done so in cups of hot water. Formula is always given at room temperature. The infant may experience a flow that is variable or too rapid due to hydrostatic pressure which varies depending on the volume in the bottle and the angle the bottle is held by the caregiver. Higher hydrostatic pressure results in increased flow rates and may overwhelm the infant who is trying to learn to feed. The angle or manipulation of the bottle can result in feed entering the baby's mouth when the baby is trying to swallow or breathe resulting in gagging or aspiration.

Some bottles are not vented or do not vent reliably resulting in the baby having to suck against an increasing vacuum. As the baby depletes the baby bottle, vacuum builds up requiring increased suction for feeding. Caregivers control the vacuum by removing the bottle from the baby's mouth but may do so inconsistently creating varying degrees of vacuum during feeds. During early introduction of the bottle, the infant often tires or is otherwise unable to complete the feed using the nipple. In such cases, the remaining milk or formula must be transferred to another container to be delivered through an oral gastric or nasogastric (NG) tube further increasing the cost and complexity by consuming additional tube-sets and syringes. If a syringe pump is used to administer the remaining feed, the full volume cannot be delivered because of the liquid that remains in the tubing when the syringe reaches it limit.

Neonatologists rely on subjective nursing reports and observations of feeding patterns to advance feeds; quantifiable data is limited to calculations of volume fed over time. Sometimes an infant is advanced before being ready only to regress creating more inconsistency. As a result feeding incompetency is one of the primary reasons infants remain in the Neonatal Intensive Care Unit (NICU) when they otherwise would be ready to go home.

Various means have been devised to address some of these problems. A device described in US Patent Publication 2009/0208193 to Bauer et. al., uses warm air to heat breast milk or formula to a precise temperature, but is not able to maintain that temperature once the bottle is removed from the warmer. Another system attempting to address nursing competency is illustrated in U.S. Pat. No. 6,033,36 to Goldfield. Goldfield's invention uses a signal from a breath sensor to control a liquid feeding valve which supplies nutrients through a feeding nipple in a controlled manner. The device is able to restrict flow when the baby needs to breathe which may avoid aspiration problems but does not address other problems noted above. In U.S. Pat. No. 6,966,904, Ruth describes a manually adjustable valve to control the flow of fluid through a conduit that connects a fluid chamber to the nipple. By following a regimen where the restriction of the flow of fluid is initially blocked and then gradually relaxed over a series of feedings, this device is intended to encourage stronger sucking. U.S. Pat. No. 3,790,016 to Kron illustrates a system where fluid flow is not responsive to compression of the nipple, to encourage vacuum-type sucking, even though some researchers believe that nipple compression is an essential component of healthy nursing. None of these devices has been widely accepted for use in the NICU and may only add to the confusion faced by infants attempting to cope with the world they have entered prematurely.

The inventors of the present invention believe that to master the suck/swallow/breath skills needed to progress from tube feeding to full oral feeds, a neonate needs a consistent learning environment. Therefore, it is an object of the present invention to provide a feeding system where the liquid feed in the nipple is maintained at substantially neutral pressure throughout the feeding session. By avoiding pressure or vacuum in the nipple, the system allows the infant to feed at its own pace using sucking and/or compression to draw fluid from the nipple. Another object of the present invention is to heat the liquid feed at a point very near the point of delivery to the infant such that the temperature introduced to the infant is substantially equal to a predetermined temperature, preferably close to body temperature. It is another object of this invention to provide a sensor responsive to fluid in a fluid reservoir which provides a signal that can be used in a feedback system to control fluid transfer to the reservoir in coordination with the sensor signal. It is still a further object of the present invention to monitor and report the rate at which the baby is taking fluid from the bottle throughout the feeding session. It is yet another object of this invention is to provide a visual display of sucking activity to enable the caregiver to monitor the baby's sucking behavior. It is another object of this invention to combine data from one or more feeding sessions and to estimate a “maturity index” to help caregivers assess the progress the baby is making in transitioning from tube feeding to oral feeding. Another object of the present invention is to allow substantially all of the nutritive fluid to be delivered to the infant during the feeding session. Yet another object of this invention is to provide the capability to easily change the delivery device from a nipple to an NG tube to allow the caregiver to introduce the bottle and nipple for a portion of the feeding session but to complete the delivery with an NG tube. A further object of the present invention is to provide tubing materials that avoid components of the nutrient fluid from sticking to the inside wall of the tube due to the tendency of some plastics to absorb protein or fats. It is a still further object of the present invention to compare identifying information about the feed and the infant and to warn the caregiver or block operation of the feeding system if the feed is not appropriate for the infant.

These and other objects and advantages of the present invention will become apparent to those skilled in the art upon a review of the following detailed description of the preferred embodiments and the accompanying drawings.

### SUMMARY OF THE INVENTION

The present invention is generally directed to a feeding system for infants. In a preferred embodiment the system aids infants having a sensorimotor deficit of breathing/swallowing/sucking competence to develop necessary skills to transition from tube feeding to oral nutritive feeding. The feeding system embodies several technologies and consists of multiple components including a base unit, a hand-held module and a disposable tube set. In a preferred embodiment of the present invention, the base unit includes an area for positioning a vessel containing an initial volume of nutritive fluid to be fed to the infant. The nutritive fluid may be expressed breast milk or formula. In one embodiment, the resting area for the vessel is a slightly angled surface so that vessel tilts to facilitate removal of all of its liquid contents. The disposable tube set may include a semi-rigid, straw-like tube at one end which is inserted into the vessel in such a manner to allow the distal end of the straw-like tube to rest in the lowest portion of the liquid volume. A cover on the vessel may be configured to guide and support the position of the straw-like tube. In another embodiment the feed may be provided in a flexible bag that collapses as the liquid feed is removed. The tube set in such an embodiment may include a rigid connector or other means known in the art for accessing the liquid contained in the flexible bag.

In a preferred embodiment, a display and/or other user interface elements for user input and feedback are located in the base unit. Such a user interface allows information about the infant, the caregiver, and the feeding session to be entered for electronic storage. In one embodiment of the present invention, the user interface may include a bar code reader or other means to enter data about the infant and the feed and to further include control algorithms to warn the caregiver or block operation of the feeding system if the feed is not appropriate for the infant (for example if the bar code on a bag of expressed breast milk does not match the code provided by the mother of the infant). In a preferred embodiment the base unit is connected to the hand held module by an electrical cable with conductors suitable for providing power and transmitting electrical signals for communication between the base unit and the hand held module.

The tubing of the disposable tube set provides a fluid path from the initial volume of nutritive fluid to the hand held module. In one embodiment of the invention, the vessel containing the initial volume of nutritive fluid may be positioned such that gravity provides adequate motive force to transfer the liquid feed from the vessel to the hand held module. In this embodiment an electrically driven valve, which is configured to control the flow of the nutritive fluid, is operated by signals from the base unit in coordination with control algorithms described below. In another embodiment the initial volume of nutritive fluid may be contained in a syringe which is placed in an electrically driven apparatus operated by signals from the base unit in coordination with control algorithms described below. Other means for transferring fluid which provide both control of the flow from the initial volume of nutritive feed to the reservoir and a fluid-tight isolation of fluid in the disposable tube set from atmospheric pressure at the proximal end may be employed within the scope of the present invention.

In a preferred embodiment, such fluid transfer means comprises flexible tubing routed around the head of a peristaltic pump in which the flexible tubing is pinched thereby isolating fluid in the tubing from atmospheric pressure at the proximal end. The peristaltic pump is operated by signals from the base unit to control the flow of the nutritive fluid unit in coordination with control algorithms described below. In such an embodiment, the tubing also may be engaged with a bubble detector able to sense the presence of air as an indication that all of the initial volume of nutritive fluid had been removed from the vessel. Fluid control algorithms may include procedures that continue to transfer the nutritive fluid after the detection of air by the bubble detector for extended times or volumes to allow substantially all of the nutritive fluid to reach the hand held module. Such extended times or volumes may be determined by measuring the volume of fluid that can be emptied from a full disposable tube set and calculating the time to dispense such volume at actual flow rates. If tube sets of different capacity are provided, the different volumes may be coded to match the specific tube set and such code provided to the system during set up.

The tubing may be formed from one or more segments of tubing made from different materials and welded or otherwise bonded to form a continuous length of tubing. The rigid or semi-rigid end of the tubing that accesses the initial volume of liquid feed may be joined to a segment of tubing with a different wall thickness, diameter, and flexibility, that is adapted to work with a peristaltic pump. A subsequent length of tubing may be joined to the flexible segment having sufficient length to extend from the base unit to the hand held module, a distance of approximately 50 inches, so that the caregiver can sit while feeding the infant. In a preferred embodiment the substantial length of tubing extending from the base unit to the hand held module has a small inside diameter, preferable less than 0.060 inches, in order to reduce the volume of feed needed to fill the tubing. In addition, the tube may be fabricated from materials that have low protein absorption properties, or from laminated materials where the inner surface is chosen to be a polymer with low protein absorption properties, to reduce the loss of components in the nutritive fluid. Polymers with low binding properties include ethylene vinyl acetate (EVA), polypropylene, olefin and low density polyethylene (LDPE).

In a preferred embodiment of the present invention, the disposable tube set includes a heating cartridge between the intake tube and the nipple outlet that facilitates heating the nutritive fluid. The heating cartridge may be formed from the tubing itself or may be a component fabricated separately and joined to the tubing. The heating cartridge facilitates heating the nutritive fluid by providing a significant surface which is in contact with both the liquid and one or more heating elements. Various forms of heating elements are known in the art and may be used to contact the heating cartridge. In a preferred embodiment the heating element comprises an electrical resistive conductor sealed within a non-conductive heating pad and placed in close proximity with a temperature sensor for measuring the temperature and controlling the electrical energy delivered to the resistive conductor. Using control algorithms well known in the art, the heating element may be controlled to provide varying levels of energy according to the temperature of the sensor in order to heat the nutritive fluid to a desired temperature. In one embodiment of the present invention, the desired temperature is 98° F. In another embodiment the desired temperature is 96° F.+/−2° F. In still another embodiment of the present invention the desired temperature may be set to different levels between body temperature and room temperature (approximately 98° F. to 70° F.) in order to transition an infant from body temperature feed to room temperature feed.

The hand held module is generally the size and shape of a baby bottle and is intended to be easily held in the hand of the caregiver while feeding the infant. The hand held module has a fluid reservoir connected to the disposable tube set and able to contain a portion of the initial volume of nutritive fluid. A nipple, suitably sized and shaped for low birth weight infants, is mounted on the end of the hand held unit so that the caregiver can place the nipple in the infant's mouth. The nipple is in fluid communication with the reservoir and in a preferred embodiment, forms a part of the reservoir such that the volume of the nipple is a substantial portion of the total volume of the reservoir. A flexible membrane also forms a portion of the exterior wall of the fluid reservoir such that one surface of the flexible membrane faces the inner volume of the fluid reservoir.

When the fluid reservoir is full of nutritive fluid, further transfer causes the flexible membrane to be stretched away from the inner volume. Similarly when the infant sucks some of the fluid from the nipple which is in fluid communication with the fluid reservoir, the flexible membrane is stretched into the inner volume of the fluid reservoir. In one embodiment of the present invention, a reservoir sensor is a pressure sensor in operative engagement with the flexible membrane for developing a signal indicative of the instantaneous internal pressure of the reservoir. In another embodiment of the present invention the reservoir sensor is a position sensor disposed to sense the position of the outer surface of the flexible membrane for developing a signal indicative of the position of the flexible membrane relative to the reservoir.

In a preferred embodiment of the present invention the feeding system includes a feedback system connected to the fluid transfer means which controls fluid transfer from the initial volume of nutritive fluid to the fluid reservoir in the hand held module according to the signal generated by the reservoir sensor. In such an embodiment if the reservoir sensor indicates that fluid is being removed from the reservoir, the fluid transfer means can be operated or the flow rate increased to replace the fluid. If the rate of transfer into the reservoir exceeds the rate at which the infant is removing liquid, feedback from the reservoir sensor is used to reduce or stop the transfer of nutritive fluid. By employing a proportional-integral-derivative controller (PID controller) feedback system, well known in industrial control systems, the flow of nutritive fluid is controlled such that fluid is replaced substantially at the same rate that it is removed and only small, momentary changes in pressure or vacuum are experienced within the volume of feed contained within the nipple.

In one embodiment of the present invention the control system uses a PID loop to control the fluid transfer into the reservoir to maintain the signal near a set-point value that corresponds to a relative pressure of the fluid in the reservoir that is between a negative pressure able to draw air into the reservoir, and a positive pressure able to expel fluid from reservoir, through the fluid outlet. The inventors of the present invention have found that it is advantageous to establish a set-point value that corresponds to a slight flexing of the flexible membrane into the volume of the fluid reservoir. Under these conditions, when the caregiver tilts the nipple opening downward, or if the infant releases contact with the nipple, the slightly stretched flexible membrane will tend to keep liquid from dripping out of the nipple. Since it is an object of the present invention to reduce pressure or vacuum forces within the nipple, the feedback system of the present invention is desirably set to maintain the flexible membrane at a flexure that just keeps the liquid from dripping when the nipple-opening is held in the traditional feeding position. In a preferred embodiment the set-point value for the feedback system is established at the beginning of each feeding session, prior to placing the nipple in the infant's mouth. Establishing the set-point may be accomplished by reading the instantaneous value of the reservoir sensor when the hand held module is turned to the feeding position and adjusting the value by a predetermined off-set. The off-set value may be predetermined, for example, through experimentation on prior systems by measuring values of signals from the reservoir sensor which correspond to off-sets from a neutral membrane position sufficient to keep the liquid from dripping. The determination of when to take the set-point reading may be triggered by the user, for example, pressing a button on the base unit when the hand-held module is placed in the feeding position. Alternatively the hand-held module may include internal gravity-detecting sensors or an electronic inclinometer or accelerometer that monitors the orientation of the hand held module and the microprocessor can initiate the set-point reading the first time after priming that the hand-held module is positioned with the nipple in a downward orientation. Subsequent to establishing the set-point, the replenishment of fluid into the reservoir is controlled by the feedback system to maintain the value of the signal from the reservoir sensor very close to the set-point thereby minimizing hydrostatic pressure or vacuum at the outlet of the nipple.

The feeding system of the present invention is also capable of monitoring the fluid transfer means and recording the volume of nutritive fluid delivered as a function of time. The cumulative or instantaneous volume of fluid taken by the baby may be displayed in real time on a graphical display to indicate the baby's feeding progress to the caregiver. By recording the volume delivered and the timing, the feeding system is able to perform calculations such as feeding proficiency (percent of volume in first 5 minutes) and efficiency (ml/minute averaged over the active feeding period) and to display these at the completion of the feeding session.

In one embodiment of the present invention, the hand held module includes a display such as a Liquid Crystal Display (LCD) or a display comprising multiple Light Emitting Diodes (LED), in communication with the reservoir sensor. In such an embodiment, the display is directed to indicate the direction and approximate magnitude of instantaneous signal changes coming from the reservoir sensor. Thus the caregiver is able to monitor the timing and relative strength of the sucking behavior when the infant removes feed from the reservoir. Observation of this display may help caregivers assess the progress the baby is making in transitioning from tube feeding to oral feeding. In one embodiment of the present invention, the feeding system is capable of recording the signals from the reservoir sensor as a function of time and performing further calculations and analysis. In such an embodiment comparison of timing, rhythm, amplitude and duration of sucking behavior may be made to previous sessions or to predetermined characteristics to derive a “maturity index” which correlates to a level of readiness for the infant to sustain full oral feeds.

If the infant is not able to take the full volume of feed from the nipple, the caregiver may choose to complete the feeding session by delivering the remaining feed using an oral gastric or nasogastric (NG) tube. Such a tube would already be in place such that only connection to the feed supply is necessary. The present invention facilitates changing the delivery device from a nipple to an NG tube by providing a connector at the distal end of the disposable feeding tube which mates to the NG tube directly or to an extension tube which mates to the NG tube. In one embodiment of the present invention, the orifice where the fluid enters the fluid reservoir is a tapered concave cylindrical shape such as a female luer connector. By removing the nipple the caregiver is able to insert a male connector into the orifice thereby forming a fluid communication path with nutritive fluid from the feeding system. In a preferred embodiment an extension tube which mates to the NG tube has a nipple adapter fitting able to attach to the nipple in a liquid-tight manner. When the extension tube is connected, the feeding system is capable of delivering the nutritive feed, warmed to a predetermined temperature, directly to the infant's NG tube. In such an embodiment, the reservoir sensor may be monitored to detect any unexpected pressure in the delivery tubing such as may be caused by an occlusion. In a preferred embodiment, the user interface of the base unit is capable of accepting input from the caregiver to deliver specific volumes or all of the remaining fluid at specified flow rates.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1a is a schematic, front view of a feeding system according to an illustrative embodiment of the invention.

FIG. 1b is a schematic, front view of a feeding system according to an alternative embodiment of the invention.

FIG. 1c is a schematic, front view of a feeding system according to another alternative embodiment of the invention.

FIG. 2 is a schematic, prospective view of a hand held module according to an illustrative embodiment of the invention.

FIG. 3 is a schematic, interior view of a hand held module according to an illustrative embodiment of the invention.

FIG. 4 is a schematic, side view of the heater cartridge, fluid reservoir and disposable tube set separated from the base unit and the hand held module according to an illustrative embodiment of the invention.

FIG. 5 is a schematic bottom view of the heater cartridge and fluid reservoir of FIG. 4 taken along the cross section 5-5′ according to an illustrative embodiment of the invention.

FIG. 6 is a schematic flow diagram of a feedback and control system according to an illustrative embodiment of the invention.

FIG. 7 is a schematic, exploded view of heating pads and the heater cartridge according to an illustrative embodiment of the invention.

FIG. 8a is a schematic, exploded view of the hand held module according to an illustrative embodiment of the invention.

FIG. 8b is a schematic, prospective view of the hand held module configured for enteral feeding according to an illustrative embodiment of the invention.

FIG. 8c is a schematic, exploded view of the hand held module configured for enteral feeding according to an illustrative embodiment of the invention.

FIG. 9 is a schematic flow diagram of a performance measuring system according to an illustrative embodiment of the invention.

FIG. 10 is a schematic, prospective view of a self-contained feeding system according to an illustrative embodiment of the invention.

FIG. 11 depicts a cross section of an alternate embodiment of the flexible membrane of FIG. 5 in an illustrative embodiment of the invention.

### DETAILED DESCRIPTION

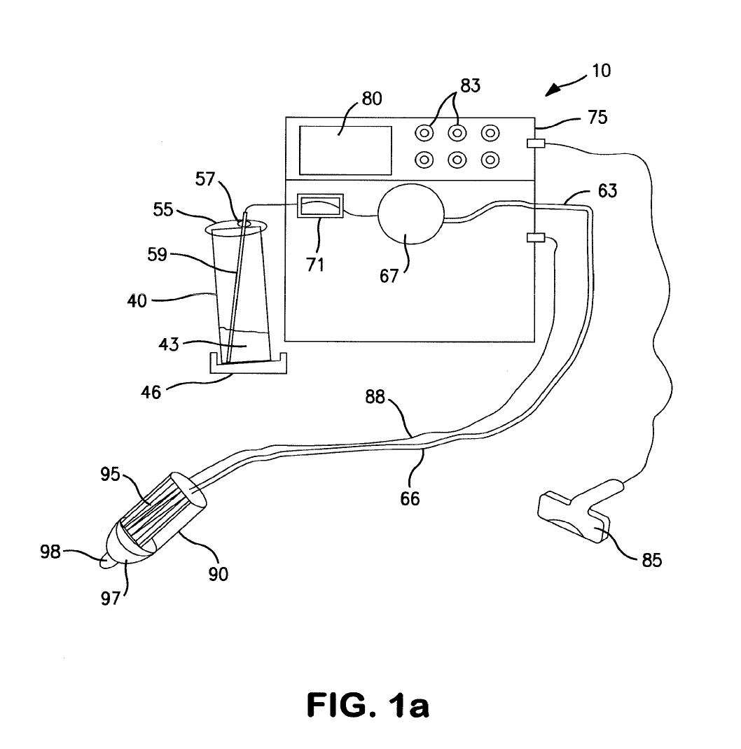

Referring now to FIGS. 1-5, embodiments of the present invention will be more thoroughly described.

FIG. 1a depicts components of a feeding system 10, in accordance with an embodiment of the present invention as it might be configured to rest on a counter, table, or other flat surface. The feeding system 10 for feeding a nutritive fluid to a neonate includes a vessel 40 containing an initial volume of nutritive fluid 43 to be fed to the neonate (not shown). The vessel 40 is positioned in a holder 46 which supports the vessel in such a manner that the bottom surface of the vessel is angled relative to the horizontal plane to allow small amounts of liquid to flow to a predetermined low-end point in the vessel. The vessel may be a container normally provided with nutritive formula or a plastic bottle with expressed breast milk which has been prepared for the feeding. The open top of the container may be covered with cover 55 which has a hole 57 through which a semi-rigid intake tube 59 is inserted. The hole 57 may be advantageously positioned and shaped to support the tube 59 to ensure the open end of the tube rests in the low-end point the vessel.

In the depicted embodiment, the intake tube 59 is connected to a more flexible pumping tube segment 63 which is placed in operative engagement with the head of a peristaltic pump 67. The pumping tube segment 63 may be positioned in an air bubble detector 71. The bubble detector 71 may use conductive, capacitive or ultrasonic detection means as is well known in the art for sensing air in the pumping tube segment 63 which will occur when the nutritive fluid 43 is depleted or may occur in case of an erroneous condition such as the intake tube 59 being inadvertently pulled from the nutritive liquid 43. The peristaltic pump 67 may use a motor and electrical control technology well known in the art and is housed in a base unit 75. The base unit 75 may further contain a display 80 and user interface elements 83, such as buttons, switches and indicators to allow the user to interact to control and get information as will be further described below. In the depicted embodiment of the present invention, the user interface includes a bar code reader 85 to enter information about the infant and the feed. The base unit 75 is connected to a hand held module 90 by an electrical cable 88 with conductors suitable for providing power and transmitting electrical signals for communication between the base unit 75 and the hand held module 90.

The pumping tube segment 63 is further connected to a transfer tube segment 66 which continues the fluid path to a heater cartridge 95 and a fluid reservoir 97 positioned within the hand held module 90. The fluid reservoir 97 has a structure which allows its volume to vary in response to the quantity of nutritive fluid within the fluid reservoir 97. In use, the peristaltic pump 67 acts on the pumping tube segment 63 to transfer a portion of the initial volume of nutritive fluid 43 to the fluid reservoir 97. The fluid reservoir 97 includes a nipple 98 in fluid communication with the nutritive fluid 43 and has at least one fluid outlet. In use the caregiver holds the hand held module 90 and places the nipple 98 in the mouth of the infant. When the infant sucks, nutritive fluid is drawn out through the nipple 98 thereby decreasing the volume of the fluid reservoir 97. Through a sensing means able to measure the instantaneous volume of the fluid reservoir 97 and a feedback system described below, the peristaltic pump 67 is controlled to transfer additional nutritive fluid 43 from the vessel 40 to the fluid reservoir 97 thereby replenishing the supply for the infant's continued feeding.

FIG. 1b depicts components of a feeding system 100, in accordance with an embodiment of the present invention as it might be configured to be supported on a pole-stand and to utilize gravity as the source of energy for a fluid transfer means. In the depicted embodiment, the feeding system 100 includes a feed supply vessel 140 suitable for containing nutritive liquids and an initial volume of nutritive fluid 143 to be fed to the neonate (not shown). The feed supply vessel 140 is supported by a holder 146 which supports it at a height sufficiently above the height of the nipple 98 so that gravity is able to cause liquid to transfer from the feed supply vessel 140 to the nipple 98. The nutritive fluid 143 may be nutritive formula or expressed breast milk which has been prepared for the feeding. The feed supply vessel 140 may be made of flexible materials or from inflexible plastic or glass materials suitable for containing nutritive liquids as is well known in the art. If the feed supply vessel 140 is relatively inflexible, it may further contain a one-way valve or filter/vent 157 which allow air to enter the vessel as the liquid is removed.

In the depicted embodiment, the intake tube 159 is inserted into the feed supply vessel 140 in such a manner to ensure the open end of the intake tube 159 rests in the lowest level of liquid in the feed supply vessel 140. The intake tube 159 is connected to a more flexible pinch tube segment 163 which is placed in operative engagement with pinch valve 167. The pinch valve 167 may use electro-motive or pneumatic control technology to pinch the tube thereby metering the flow of liquid as is well known in the art. Pinch valve 167 is operatively connected by suitable air or electrical conductors 168 to the base unit 175. The pinch tube segment 163 further may be positioned in an air bubble detector 171 using technology well known in the art to sense air in the tubing. The air bubble detector 171 is connected to the base unit 175 by electrical cable 173 in order to supply signals which may be used in control algorithms as will be further described below. The base unit 175 is connected to the hand held module 90 by an electrical cable 88 with conductors suitable for providing power and transmitting electrical signals for communication between the base unit 175 and the hand held module 90.

In the depicted embodiment of FIG. 1b, the pinch tube segment 163 is further connected to a transfer tube segment 166 which continues the fluid path to a heater cartridge 95 and a fluid reservoir 97 positioned within the hand held module 90. The fluid reservoir 97 includes a nipple 98 in fluid communication with the nutritive fluid which is placed in the infant's mouth for feeding. A sensing means according to the present invention is provided within the hand held module 90 and provides feedback to control the pinch valve 167 to allow the transfer of nutritive fluid 143 from the vessel 140 to the fluid reservoir 97 in response to the infant's feeding.

FIG. 1c depicts components of a feeding system 200, in accordance with an embodiment of the present invention as it might be configured to utilize a syringe pump 267 as a fluid transfer means. In the depicted embodiment, the feeding system 200 includes an enteral feeding syringe 240 and an initial volume of nutritive fluid 243 to be fed to the neonate (not shown). The feeding syringe 240 is positioned within the mechanized syringe pump 267 which may use a motor and electrical control technology well known in the art. The syringe pump 267 may be a stand-alone device or integrated with a base unit 275. The base unit 275 is connected to the hand held module 90 by an electrical cable 88 with conductors suitable for providing power and transmitting electrical signals for communication between the base unit 275 and the hand held module 90.

In the depicted embodiment of FIG. 1c, a flexible transfer tube segment 266 provides a fluid path from the feeding syringe 240 to a heater cartridge 95 and a fluid reservoir 97 positioned within the hand held module 90. The fluid reservoir 97 includes a nipple 98 in fluid communication with the nutritive fluid 243 which is placed in the infant's mouth for feeding. A sensing means according to the present invention is provided within the hand held module 90 and provides feedback to control the syringe pump 267 to provide transfer of nutritive fluid from the feeding syringe 240 to the fluid reservoir 97 in response to the infant's feeding.

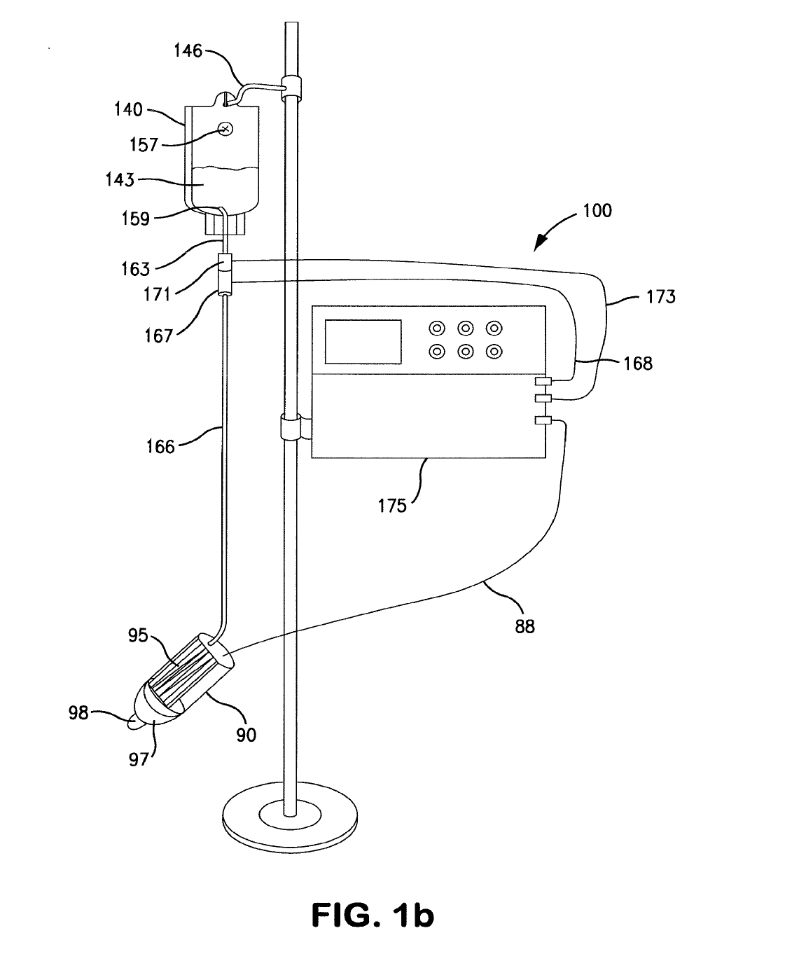

FIG. 2 depicts the hand held module 90 according to an illustrative embodiment of the invention. The hand held module 90 has a lower housing 403 and an upper housing 409 which hinge together to form a substantially cylindrical shape. Latches 413 and 415 secure the two housings together when the hand held module 90 is in use. The fluid reservoir 97 is joined to the nipple 98 by a conventional nipple ring 417.

A display panel 425 is positioned to be easily viewed by the caregiver while using the hand held module 90. The display panel 425 has a multi-segment indicator 430 which can be used to display an indication of the sucking activity of the infant derived from the fluid reservoir sensor described below. Other indicators, such as displays 435, 436, and 437, display temperature information coming from temperature sensors within the hand held module 90. Display 435 is illuminated blue if the internal heating system is cooler than the preset operating temperature. Display 436 is illuminated green if the internal heating system is at the preset operating temperature or within normal variations of this temperature. Display 437 is illuminated red if the temperature of the nutritive fluid exceeds a preset maximum allowable temperature.

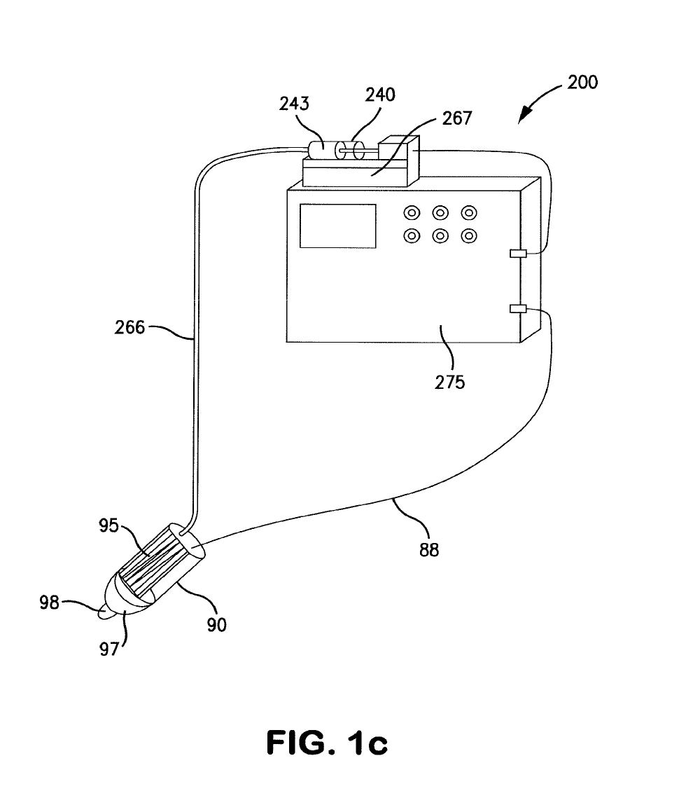

FIG. 3 depicts an interior view of a hand held module 90 according to an illustrative embodiment of the invention in a configuration where the upper housing 409 is hinged open. The electrical cable 88 is connected at the proximal end of the lower housing 403 and conductors in the cable pass into the interior of the hand held module 90 where they are connected to provide power and transmit electrical signals for communication between the base units 75, 175, or 275 (FIGS. 1a, 1b, 1c) and the hand held module 90. The flexible transfer tube 66 is joined to the proximal end of the heater cartridge 95. The heater cartridge 95 is formed from a thin channel substrate 450 that contains a serpentine fluid pathway 458 sealed by a sealing film 451. The channel substrate 450 is configured to facilitate heat transfer into the serpentine fluid pathway 458 through which the nutritive fluid passes in transit from the feeding source to the fluid reservoir 97. The serpentine fluid pathway 458 may be created by forming channels in the channel substrate 450 in an injection molding process and then covering the channels with sealing film 451. At the distal end of the serpentine fluid pathway 458, the fluid path widens to form a measuring chamber 460. The temperature of the nutritive fluid contained within measuring chamber 460 can be measured by means known in the art and this measurement used to monitor the temperature of the nutritive fluid prior to it entering the fluid reservoir 97.

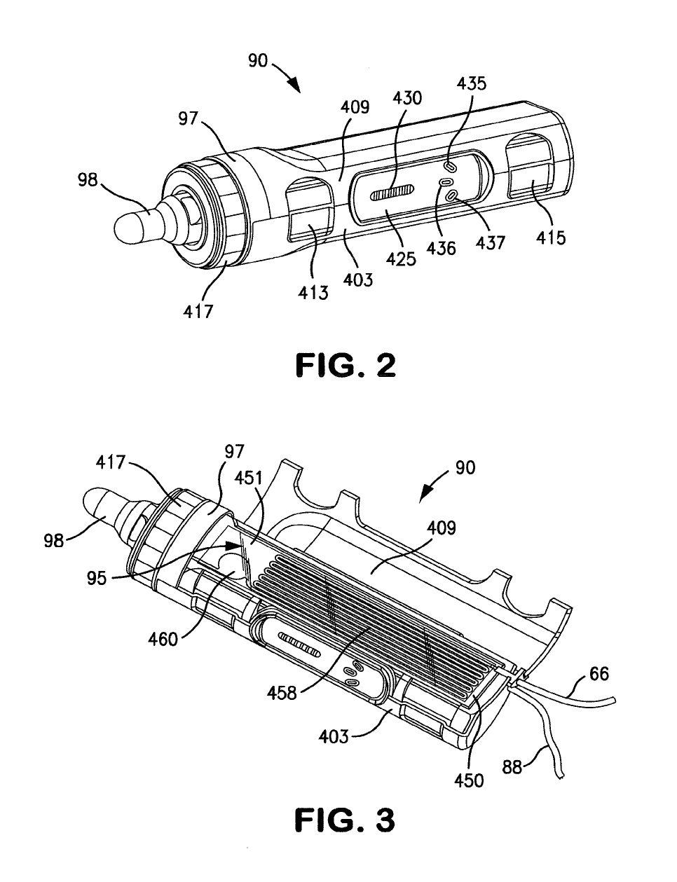

FIG. 4 depicts the heater cartridge 95 and disposable tube set 462 according to an illustrative embodiment of the invention, as it may appear when separated from the base unit and the hand held module. The semi-rigid intake tube 59 connects to flexible pumping tube segment 63 which is formed of a flexible plastic material suited for engagement by rollers in the head of peristaltic pump 67 (FIG. 1a). The flexible pumping tube segment 63 is joined to transfer tube segment 66 which is sufficiently long to reach from the base unit 75 (FIG. 1a) to the caregiver who may be seated next to the base unit 75. In certain embodiments the transfer tube segment 66 has a small inside diameter, preferable less than 0.060 inches, in order to reduce the volume of nutritive fluid needed to fill the tubing. In addition, the transfer tube segment 66 may be fabricated from materials that have low absorption properties, or from laminated materials where the inner surface is chosen to be a polymer with low absorption properties, to reduce the loss of components in the nutritive fluid. Polymers with low binding properties include ethylene vinyl acetate (EVA), polypropylene, olefin and low density polyethylene (LDPE).

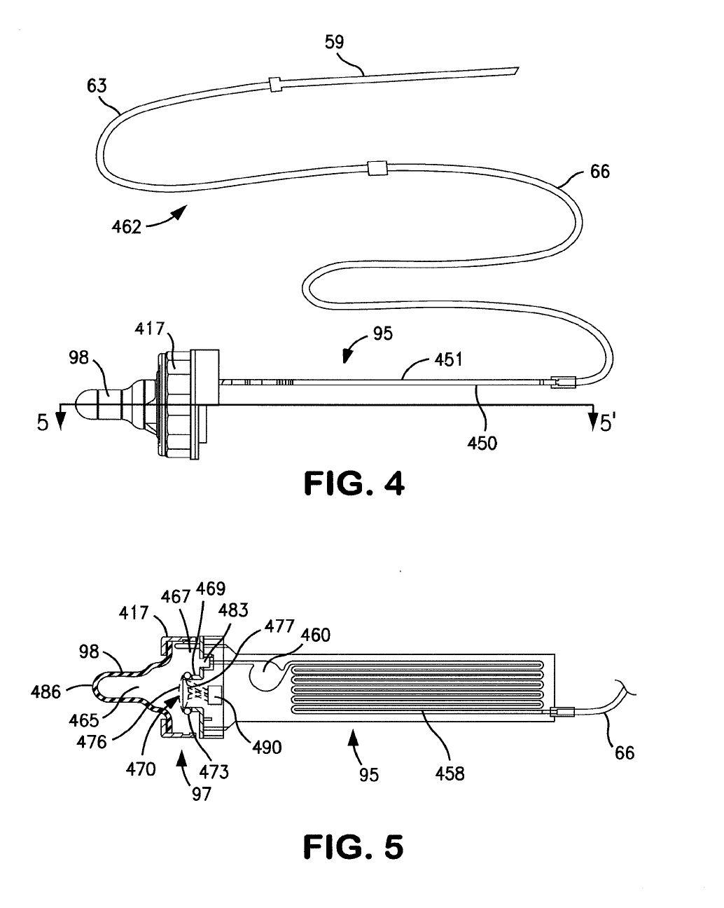

FIG. 5 depicts the schematic bottom view of the heater cartridge 95 and fluid reservoir 97 of FIG. 4 taken along the cross section 5-5′ of FIG. 4 according to an illustrative embodiment of the invention. The distal end of transfer tube segment 66 is bonded to the heater cartridge 95 in such a manner to form a continuous sealed liquid pathway between the transfer tube segment 66 and the serpentine fluid pathway 458. At the distal end of the serpentine fluid pathway 458, the fluid path widens to form a measuring chamber 460 and then connects to fluid reservoir 97. The fluid reservoir 97 is a semi-enclosed volume assembled from more than one component and encompassing internal volume 465. The internal volume 465 is bounded by nipple 98, cylindrical section 467, membrane support section 469, and flexible membrane 470. The flexible membrane 470 is secured to the membrane support section 469 by O-ring 473 or by other means known in the art for attaching a flexible elastomeric membrane to a solid support. The flexible membrane 470 may be molded or cut from sheet membrane material and may be formed from natural or synthetic rubber, elastomeric polymers such as silicone or other elastic materials.

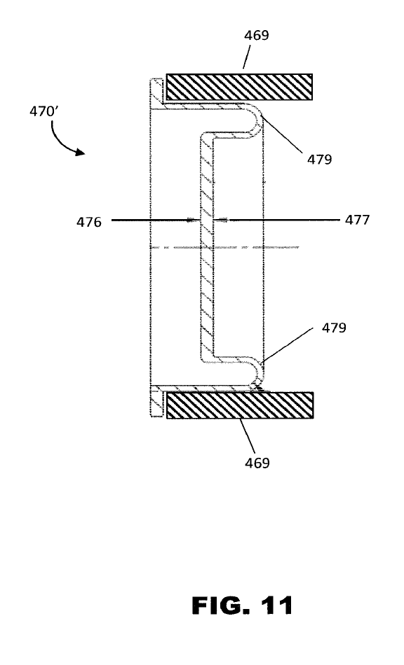

FIG. 11, taken along with FIG. 5, depicts a cross section of an alternate embodiment of the flexible membrane of FIG. 5 in an illustrative embodiment supported on membrane support section 469. The flexible membrane 470′ is molded with a rolling section 479 shaped to allow changes in the position of the membrane internal surface 476 and hence changes in the reservoir internal volume 465 with minimal stretching of the flexible membrane material. An internal surface 476 of flexible membrane 470′ is in contact with the nutritive fluid when it fills internal volume 465. The external surface 477 of flexible member 470′ faces sensor 490. The material of the flexible membrane 470′ may be formed by injection molding techniques using TPE, a thermoplastic polyester elastomer which is an engineering rubber having combined properties of conventional rubber and thermoplastic. Advantageously by using injection molding techniques, the thickness of the membrane section comprising the membrane external surface 477 may be thicker than the rolling section 479. A thickness between internal surface 476 and external surface 477 of between 0.030 and 0.045 inches (as compared to a thickness in the rolling section 479 of between 0.010 and 0.020 inches) makes the external surface 477 less flexible and provides a well-behaved movement to be detected by sensor 490. In one embodiment of the present invention sensor 490 comprises an optoelectronic circuit which uses optical reflections for measurement of the position of external surface 477. In such an embodiment it is advantageous for the membrane to be opaque at the wavelengths of light being used. Proper levels of opacity may be achieved by adding a disk of opaque material to the central area of external surface 477 or by a combination of thickness and doping material added to the molding resin from which the flexible membrane 470′ is made. The inventors have determined that adding 4-5% by weight of Titanium Dioxide to the TPE material provides a suitable opaque white surface (<1% transmission at red wavelengths).

Returning now to FIG. 5, when the feeding system 10 (FIG. 1a) is first readied for a feeding session, the disposable tube set 462 (FIG. 4) must be primed with nutritive fluid. A simple procedure for this is to preset the priming volume to a quantity determined during factory setup to deliver slightly less fluid than the total void volume of the fluid path. Delivering less volume is preferred since excess volume will be expelled through nipple outlet 486 creating a clean-up problem. Additional “touch-up” priming can be provided by directing the user to press a momentary contact button to transfer additional fluid while the user carefully watches the liquid in the nipple. This procedure is time-consuming and prone to error since it is difficult to see liquid in the nipple in dimly lit rooms such as caregivers may encounter in feeding infants.

The inventors have determined that sensor 490 can be used to accurately stop the priming operation when the fluid reservoir 97 is full. In such an embodiment of the present invention, the output V of sensor 490 is monitored while an initial priming volume is transferred. As the nutritive fluid enters the internal volume 465 of the fluid reservoir through inlet port 483, it displaces air through nipple outlet 486. Such displacement of air causes only very small pressure changes to be detected by sensor 490 and liquid transfer can be immediately stopped if other pressures are encountered. When a priming volume equal to a predetermined safe volume has been transferred, the value of sensor 490 is recorded as Vp. Subsequently the rate of liquid transfer is slowed and the sensor output is monitored for any significant excursions greater than Vp. The inventors have determined that when the nutritive fluid completely fills the fluid reservoir 97 and attempts to exit nipple outlet 486, it causes a momentary, but abrupt increase in pressure. This change in V>Vp is used as the trigger to stop transfer of fluid resulting in a completely full reservoir with an inconsequential amount of liquid being expelled.

Once the internal volume 465 is full of nutritive fluid, the system is ready for use and the caregiver places the nipple in the infant's mouth. This action effectively seals nipple outlet 486 which closes the fluid reservoir 97 creating a structure which is liquid-tight between the nipple outlet at the distal end and the tube-occlusion at the proximal end created by peristaltic pump 67 (FIG. 1a), pinch valve 167 (FIG. 1b), or syringe pump 267 (FIG. 1c). This semi-closed system, however, has a variable internal volume 465 due to the ability of flexible membrane 470 to move. As a result of this semi-closed structure, any changes in the volume of nutritive fluid in the internal volume 465 causes membrane external surface 477 to move. When liquid is removed from internal volume 465, as for example when the infant's sucking removes nutritive fluid through nipple outlet 486, the membrane external surface 477 will move inward towards the center of internal volume 465. Conversely if the infant is not sucking and the liquid transfer means supplies nutritive fluid through inlet port 483, flexible membrane 470 will flex and external membrane surface 477 will move outward away from the center of internal volume 465.

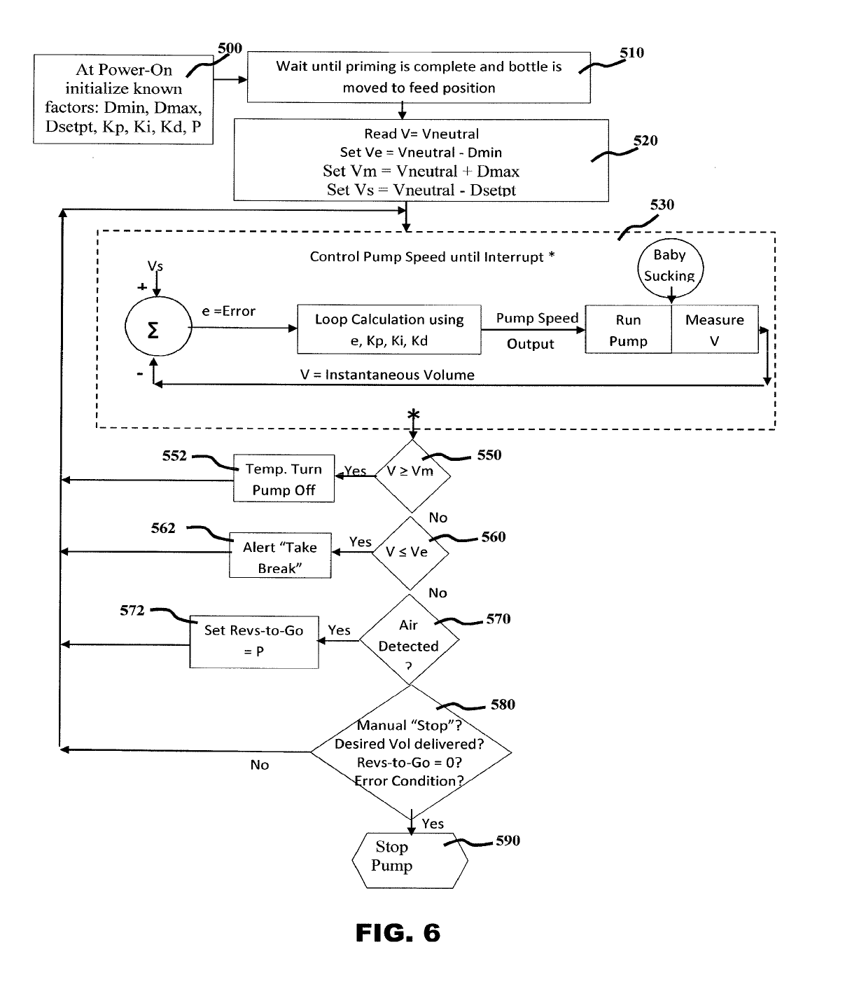

A sensor 490, able to measure the position of membrane external surface 477, provides a signal that is indicative of the instantaneous volume of nutritive fluid in the fluid reservoir 97. Position sensors capable of measuring the position of membrane external surface 477 are well known in the art and may use technologies which contact the external surface 477 such as a moving beam potentiometer, or non-contact approaches such as capacitance, magnetic (Hall Effect), ultrasonic or optical. In one embodiment an infrared light emitting diode (LED) with an output of light having wavelengths in the range 400-1000 nm illuminates the membrane and a light detector having receptivity for light wavelengths in the range 775-925 nm detects light reflected from external membrane surface 477. Digital and/or analog electronic circuits well known in the art are used to create a signal from such a light source and detector such that said signal correlates with the position of external surface 477 relative to the membrane support section 469. According to one embodiment of the present invention the value of this signal which is represented by “V” is used to control the fluid transfer means as further described in the detailed explanation of FIG. 6.

In an alternate embodiment of the present invention, sensor 490 of FIG. 5 may be a contact sensor where the sensor 490 is in direct contact with external surface 477 of the flexible membrane 470 and generates a signal which correlates to the instantaneous pressure of the internal volume 465. As the liquid transfer means supplies nutritive fluid through inlet port 483, flexible membrane 470 will stretch and pressure sensor 490 will measure an increase in pressure. Conversely when the infant's sucking removes nutritive fluid through nipple outlet 486, the flexible membrane 470 will tend to move inward toward the internal volume 465 and pressure sensor 490 will measure a decrease in pressure. According to this alternate embodiment of the present invention the value of the pressure signal from sensor 490 is used to control the fluid transfer means as further described in the detailed explanation of FIG. 6.

FIG. 6 depicts components of a control scheme, in accordance with an embodiment of the present invention as it might be configured to work with the embodiment of FIG. 1a and FIG. 5. Peristaltic pump 67 of FIG. 1a is referred to as “Pump”. The signal generated by sensor 490 is referred to as “V”. The questions and activities depicted in the flow diagram are embodied in electronics and programmable microprocessors having digital and analog input and output and memory storage capacity well known in the art and referred to here as “processors”. During development and factory setup, certain values are determined and stored in non-volatile memory. For example the offset “Dmin” may be established to correspond to the offset in sensor signal units from a “Vneutral” value that represents the smallest volume of fluid desired in the fluid reservoir. Similarly the offset “Dmax” may be established to correspond to the offset in sensor signal units from a “Vneutral” that represents the maximum fluid level desired in the fluid reservoir 97. Such a maximum is desirably less than the volume that would result in expelling liquid from the nipple outlet 486 due to stretching of the flexible membrane 470 which provides a positive return force on the fluid in the reservoir 97.

Actions indicated in step 500 are initiated on power-on or each time a feeding is initiated. Actions indicated in step 510 are initiated when the feeding system is being readied by the caregiver for feeding an infant. When the hand-held module is moved to the feeding position, the system is triggered in step 520 to take an initial reading from the sensor, “Vneutral”, corresponding to the neutral position of the flexible membrane 470. The trigger may be initiated by the user or by an internal sensor that monitors the orientation of the bottle. In step 520, this initial value “Vneutral” is used to calculate critical values of V for use in the immediate feeding session. Ve corresponds to the minimum value, Vm to the maximum value, and Vs to the “set-point” value of V.

The overall goal of the feedback and control step 530 is to adjust the pump speed to control the fluid transfer to the fluid reservoir 97 in response to the removal of fluid by the infant's sucking activity such that V is maintained close to the set-point value Vs and never reaches the minimum, Ve or maximum, Vm values. While any feedback and control algorithm which accomplishes this basic goal may be employed, a preferred embodiment uses a proportional-integral-derivative controller (PID controller) feedback system, well known in industrial control systems. During the active feeding session, the PID process illustrated in dotted lines of step 530 controls the speed of the pump, S. Those skilled in the art will understand the “Loop Calculations” shown in step 530 represent the algorithm that determines the output pump speed, S, based on the error term “e” and the known constants Kp, Ki, and Kd. The pump speed as a function of time, S(t) is determined by a sum of the three components: (1) the proportional term Kₚe(t), (2) the integral term Kᵢ∫₀^{t}e(τ)dτ, and (3) the derivative term

$${K}_{d} \frac{d }{d t} e ( t ) .$$

Those skilled in the art will understand that values for Kp, Ki and Kd are predicated on the system design and may be determined by experimentation to give responsive and stable performance.

Parallel to the activities in step 530, the processor monitors for interrupts and takes appropriate actions indicated by moving control to the * at the bottom of step 530. Also in parallel, other elements of the processor record the rotations of the pump and the instantaneous value of V as a function of time (not shown). Based on these readings the processor calculates, records and may display information to the caregiver on the display 80 (FIG. 1a). For example, the rotations of the pump allow the processor to calculate the volume of nutritive fluid delivered during various segments of time and cumulatively over the entire feeding session. The processor may also display a signal determined from the sensor output, V as a function of time. Such a signal can be displayed to indicate sucking activity of the neonate using the multi-segment indicator 430 (FIG. 2).

Returning now to FIG. 6, possible events that could interrupt the normal control process are shown in steps 550, 560, 570 and 580. For example if the pump delivers more feed to the reservoir than desired, the instantaneous value of V may exceed Vm. In such a situation a test at step 550 will result in a “Yes” and the pump will be temporarily stopped. Subsequently, control will be returned to the PID loop at step 530 as if the feeding session was just starting. In the event that the infant is able to feed faster than the pump 67 can replenish the fluid reservoir 97, an interrupt may occur because V drops below the minimum desired value Ve. In such a situation a test at step 560 will result in a “yes” and the user will be alerted that feeding should be paused (“Take a Break”). Subsequently control is returned to step 530 so that when the caregiver re-introduces the nipple 98 to the baby, the feeding control algorithm can begin as if the feeding session was just starting. If air is detected by air bubble detector 71, indicating that fluid in the initial volume of nutritive fluid 43 has been exhausted, an interrupt tested at step 570 will result in a “Yes”. In such a situation the internal counter that monitors remaining rotations (“Revs-to-Go) is set to a predetermined value “P”. Such a predetermined value is programmed at factory set up to correspond to the volume needed to completely empty the disposable tube set 462 and heater cartridge 95 in order to deliver all volume of nutritive fluid to fluid reservoir 97.

Prior to completing delivery of the requested volume, if the baby tires and the caregiver manually “Stops” the feeding, or if the “Revs-to-Go” counter reaches zero due to exhaustion of feed, or if a serious error condition interrupts the session, the test at 580 will result in “yes” and the pump will be stopped. Under normal conditions, as feeding continues, the pump rotations are recorded and the volume delivered is compared to the desired volume requested. When the requested volume is consumed, a test at step 580 results in a “Yes” which stops the pump and signals “End of Feed” in step 590.

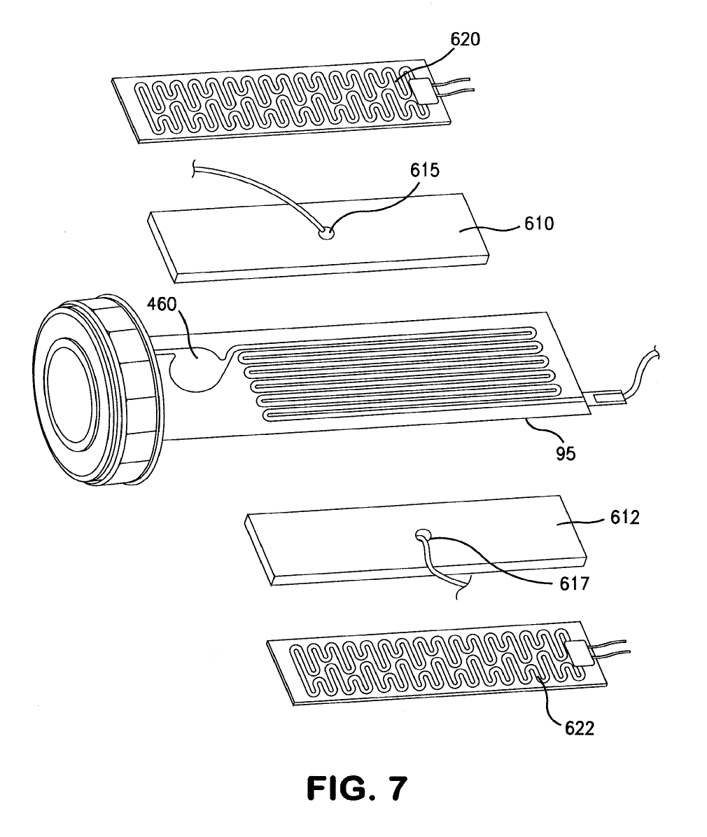

FIG. 7 depicts a schematic, exploded view of the heating system according to an illustrative embodiment of the invention. When in use heater cartridge 95 is sandwiched between a first and a second heating element. The first heating element is comprised of a heat conductive plate 610, temperature measuring sensors 615, and resistive heating element 620. The second heating element is comprised of heat conductive plate 612, temperature measuring sensors 617, and resistive heating elements 622. Each resistive heating element 620 and 622 is controlled by electronics well known in the art using the respective temperature sensors, 615 and 617 for feedback. The heat conductive plates 610 and 612, made, for example, from aluminum, serve to distribute the heat uniformly and to provide a representative point for temperature measurement. In use, the resistive heating elements 620, 622 are pressed into close contact with the heater cartridge 95. One of the two resistive heating elements is shorter or has a hole positioned to allow a non-contact temperature measuring sensor to measure the temperature of the feed in measuring chamber 460. This independent monitoring of the temperature can be used to display the temperature of the nutritive fluid immediately prior to its passage into the fluid reservoir 97 and as a safety check in case the control system fails and the resistive heating elements 620, 622 get too hot.

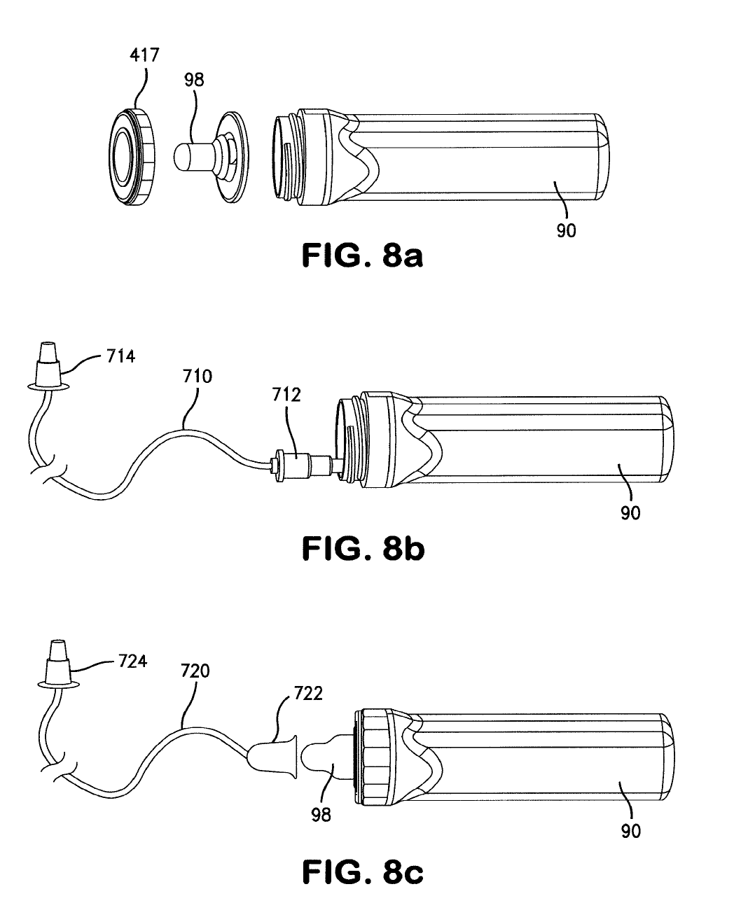

FIG. 8a depicts a schematic, exploded view of the hand held module 90 according to an illustrative embodiment of the invention. During the course of a feeding session, if the caregiver determines that the remainder of the nutritive fluid should be delivered through an oral gastric or nasogastric (NG) tube (for example if the infant tires or otherwise is unable to complete the feed using the nipple), the present invention provides an easy means to adapt the feeding system 10 to an enteral feeding system. By removing the nipple ring 417 and the nipple 98, as illustrated in FIG. 8a, an adapter tube 710 can be attached, as illustrated in FIG. 8b.

FIG. 8b depicts a schematic, prospective view of the hand held module 90 configured for enteral feeding according to an illustrative embodiment of the invention. Bottle adapter fitting 712 is configured to fit into inlet port 483 (FIG. 5). Adapter tube 710 is approximately 12 inches long and has an NG adapter fitting 714 on its distal end. The caregiver can connect fitting 714 to the existing NG tube inserted in the infant and then program the feeding system 10 (FIG. 1a) to deliver specific volumes or all of the remaining fluid at specified flow rates using the peristaltic pump 67.

FIG. 8c is a schematic, exploded view of the hand held module 90 configured for enteral feeding according to an illustrative embodiment of the invention. Extender tube 720 is approximately 12 inches long and has an NG adapter fitting 724 on its distal end. The caregiver can connect the nipple adapter fitting 722 to the nipple 98 without removing the nipple 98 from the hand held module 90. The caregiver then connects NG adapter fitting 724 to the existing NG tube inserted in the infant and programs the feeding system 10 (FIG. 1a) to deliver the desired remainder of the nutritive fluid using the peristaltic pump 67. In such an embodiment, the reservoir sensor 490 may be monitored to detect any unexpected pressure in the delivery tubing such as may be caused by an occlusion.

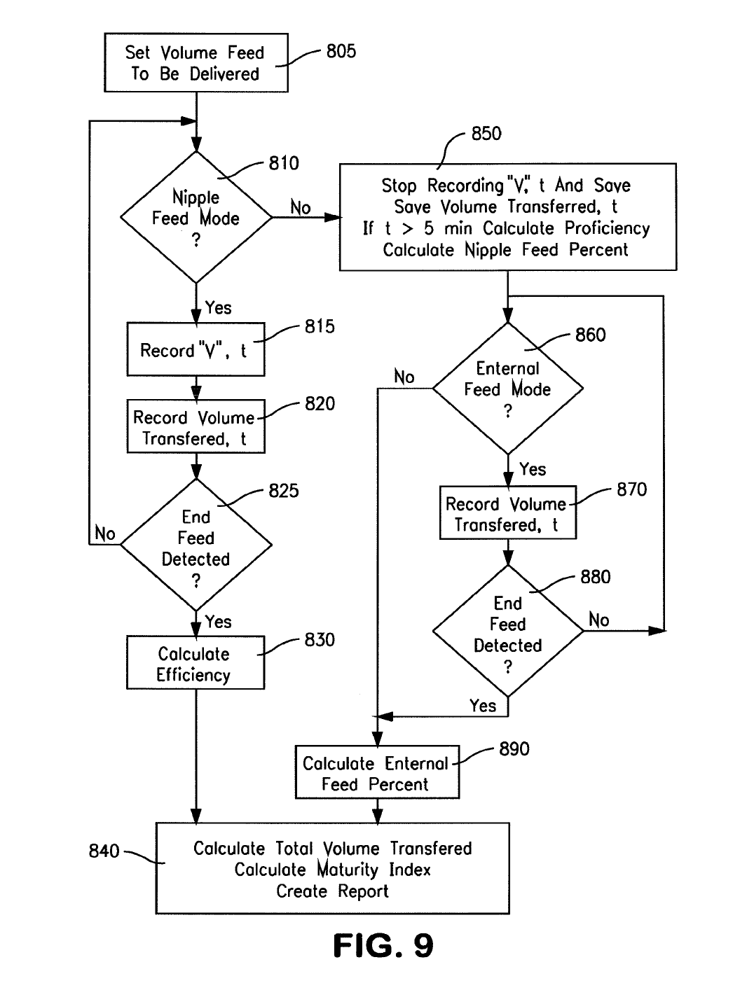

FIG. 9 depicts a schematic flow diagram of a performance measuring system according to an illustrative embodiment of the invention. As described in relation to FIGS. 8a, 8b, and 8c the feeding system of the present invention can provide nutritive fluid via a nipple (referred to as “Nipple Feed Mode” in FIG. 9), or via an NG tube (referred to as “Enteral Feed Mode” in FIG. 9). At the outset of a feeding session, according to step 805 in the flow diagram, the caregiver enters information into the system to indicate the total volume of nutritive fluid to be delivered. If the infant is being fed by nipple, the result of control step 810 is “Yes” and the system is directed in steps 815 and 820 to record the instantaneous value of “V” and the volume of fluid transferred at time “t”. If the infant is able to complete the entire feeding by mouth, the result of control step 825 is “Yes” and the system is directed in step 830 to calculate efficiency (ml/minute averaged over the active feeding period), and to complete calculations and a report in step 840. If the infant tires and the caregiver changes the mode of delivery to enteral feeding, the result of control step 810 will be “No” and actions described in step 850 are taken to calculate and save the performance measured during the nipple portion of the feeding session. In the enteral feeding mode the result of control step 860 is “Yes” and the system is directed in step 870 to record the volume transferred as a function of time “t”. When an “End Feed” status is detected in step 880, for example by air bubble detector 71 (FIG. 1a) or by the volume transferred reaching the requested Volume of Feed to be Delivered (Step 805), the result of control step 880 is “Yes” and the system is directed in step 890 to calculate the percentage of enteral feed delivered and to complete calculations and a report in step 840.

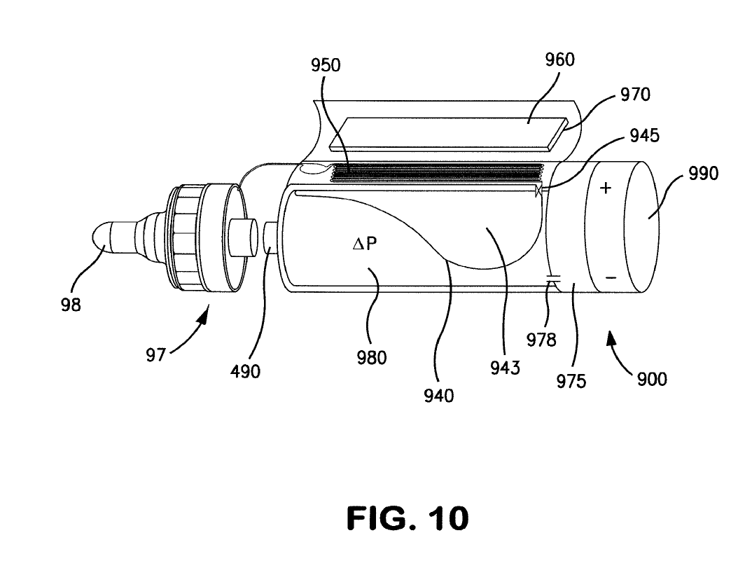

FIG. 10 depicts a schematic, prospective view of a self-contained feeding system 900 according to an illustrative embodiment of the invention. Contained within the body of feeding system 900 is a flexible bag-like container 940 filled with an initial volume of nutritive fluid 943. The outlet of container 940 passes through valve 945 and is connected to heater cartridge 950 which has the same functionality as heater cartridge 95 (FIG. 1a) described previously. The outlet of heater cartridge 950 transfers warmed nutritive fluid to fluid reservoir 97 as described in FIG. 5. Thermally conductive plate 960 is heated by resistive heating element 970 to a predefined temperature, for example 98° F., by electrical control circuitry and temperature sensing means (not shown) similar to those described in FIG. 7. Sensor 490 has the same functionality as described with respect to FIG. 5. In one embodiment of self-contained feeding system 900, the fluid transfer means is a differential pressure created, for example, by air pump 975 which pumps air through opening 978 into chamber 980. Chamber 980 is an air-tight vessel which holds container 940. In an embodiment of self-contained feeding system 900, power for electrical components is provided by rechargeable battery 990. When power from battery 990 operates air pump 975, a differential pressure ΔP is created within chamber 980 thereby pressurizing nutritive fluid 943. Valve 945 is operated by feedback and control circuitry as described for pinch valve 167 in FIG. 1b in response to signals from sensor 490. As the infant (not shown) sucks nutritive fluid from nipple 98, sensor 490 detects a loss of volume in fluid reservoir 97, and through feedback circuitry causes valve 945 to open. Nutritive fluid flows through heater cartridge 950 and fills fluid reservoir 97 which in turn is sensed by sensor 490 causing valve 945 to close. Thus the infant's sucking action controls the system to transfer warm feed into the nipple only at the rate at which it is being consumed, thereby mimicking the natural interactions of an infant breast feeding.

The feeding system of the present invention has been described with reference to providing nutritive fluids but it will be understood that alternative fluids which may be non-nutritive, medicinal, or therapeutic may also be delivered. The benefits of the invention may be applied to neonates with immature neurological systems but may also serve other infants, adults or non-human mammals that have difficulty feeding by mouth. While the present invention has been set forth in terms of a specific embodiment or embodiments, it will be understood that the present invention herein disclosed may be modified or altered by those skilled in the art to other configurations. Accordingly, the invention is to be broadly construed and limited only by the scope and spirit of the claims appended hereto.

What is claimed is:

1. A feeding system for a neonate comprising;
a fluid reservoir adapted to contain fluid to be provided to the neonate,
a nipple in fluid communication with said fluid reservoir having at least one fluid outlet adapted to enable the neonate to take the fluid therefrom by mouth,
a control system adapted to automatically maintain the pressure in the fluid reservoir substantially neutral relative to the pressure external to the fluid outlet as the fluid is taken by the neonate.

2. The feeding system of claim 1 further comprising a heating system adapted to warm the fluid, the heating system automatically maintaining the temperature of the fluid in the reservoir at a temperature near the body temperature of the neonate as the fluid is provided to the neonate.

3. The feeding system of claim 1 further comprising,
a vessel containing an initial volume of fluid to be fed to the neonate,
and a fluid transfer system for conveying fluid from said vessel to said fluid reservoir.

4. The feeding system of claim 3 wherein the fluid transfer system includes a pumping device and the control system maintains the pressure in the fluid reservoir by controlling the flow of fluid from the pumping device.

5. The feeding system of claim 4, wherein the fluid transfer system includes a disposable tube set in fluid communication between the vessel and the fluid reservoir.

6. The feeding system of claim 5, wherein the pumping device is a peristaltic pump acting on a portion of said disposable tube set.

7. The feeding system of claim 5, wherein the pumping device is a syringe pump in fluid communication with said fluid and said disposable tube set.

8. The feeding system of claim 5, wherein the pumping device is a pressure differential device with the higher pressure applied to the fluid at the end of the disposable tube set nearest the vessel relative to the pressure of the fluid in the fluid reservoir.

9. The feeding system of claim 5, wherein said disposable tube set comprises an intake tube adapted at one end to be placed in fluid communication with said initial volume of fluid.

10. The feeding system of claim 5, wherein a substantial portion of the disposable tube set has an inner surface formed from a polymer which has low protein absorption properties.

11. The feeding system according to claim 10, wherein said polymer is one of polyethylene, polypropylene, olefin or TPE.

12. The feeding system according to claim 6, wherein said disposable tube set comprises at least two lengths of tubing joined together wherein one length of tubing is adapted to operatively engage said peristaltic pump.

13. The feeding system of claim 1, further comprising a sensor capable of providing a signal indicative of at least one property of said fluid reservoir.

14. The feeding system of claim 13, wherein the fluid reservoir has a structure which allows the volume of said fluid reservoir to vary and the at least one property of said fluid reservoir is the instantaneous internal volume of the fluid reservoir.

15. The feeding system of claim 13, wherein the at least one property of said fluid reservoir is the internal pressure in said reservoir.

16. The feeding system of claim 13, wherein the at least one property is the volume of fluid contained in said reservoir.

17. The feeding system according to claim 13, wherein the sensor comprises a flexible membrane having a first surface in contact with the fluid, a second surface responsive to the movement of the first surface, and an optoelectronic circuit for developing a signal output indicative of the position of said second surface.

18. The feeding system according to claim 17, wherein said flexible membrane comprises a rolling section shaped to allow changes in the position of said second surface without significant stretching of said first surface.

19. The feeding system of claim 13, wherein said control system operates to control said fluid transfer system to maintain said signal close to a set-point value.

20. The feeding system of claim 19, wherein the set-point value is established at the beginning of each feeding of a neonate.

21. The feeding system of claim 13, further comprising a display providing a visual indication derived from the signal from the sensor.

22. The feeding system of claim 3, further comprising a device for warming the fluid to approximately 98° F. during the transfer from said vessel to said reservoir.

23. The feeding system of claim 1, further comprising a device adapted to calculate the volume of fluid taken by the neonate.

24. A feeding system according to claim 1 further comprising an extension tube having a first end removably attached to the nipple to provide a liquid-tight connection to the fluid outlet, and a second end adapted to connect to a gastric tube.

25. A method of feeding a nutritive fluid to a neonate comprising the steps of: providing a fluid reservoir containing the nutritive fluid, providing a nipple in fluid communication with the reservoir having at least one fluid outlet adapted to enable the neonate to take the fluid therefrom by mouth, sensing a property of the fluid reservoir indicative of the relative pressure within the reservoir compared to the pressure external to the fluid outlet, and controlling the pressure within the fluid reservoir to be substantially neutral while the fluid is taken by the neonate.
